(19) United States
(12) Patent Application Publication
(10) Pub. No.: US 2026/0181715 A1
(43) Pub. Date: Jun. 25, 2026

(54) COMMUNICATION DEVICE, DATA TRANSMISSION METHOD, AND DATA TRANSMISSION SYSTEM

(71) Applicant: Realtek Semiconductor Corp., HsinChu (TW)

(72) Inventors: Ding-Wei Chen, HsinChu (TW); Yi-Wen Lin, HsinChu (TW)

(73) Assignee: Realtek Semiconductor Corp., HsinChu (TW)

(21) Appl. No.: 19/411,338

(22) Filed: Dec. 7, 2025

(30) Foreign Application Priority Data
Dec. 23, 2024 (TW) 113150160

(51) Int. Cl. H04W 76/14; H04L 67/02; H04L 67/06; H04W 76/12

(52) U.S. Cl. CPC H04W 76/14; H04L 67/02; H04L 67/06; H04W 76/12

(57) ABSTRACT

A communication device includes a wireless communication module and a processor. The wireless communication module transmits or receives multiple wireless signals, and provides a hotspot, wherein the wireless communication module receives a connection request indicating to connect to the hotspot from a peer communication device, and establishes a wireless connection with the peer communication device in response to the connection request. The processor is coupled to the wireless communication module, and controls operations of the communication device, wherein after the wireless connection is successfully established, the processor utilizes a captive portal mechanism to transmit information associated with a download link to the peer communication device via the wireless communication module; and in response to a download request being received from the peer communication device, the processor transmits predetermined data to the peer communication device via the wireless communication module.

### BACKGROUND OF THE INVENTION

### 1. Field of the Invention

The present invention is related to a data transmission method, and more particularly, to a method for performing wireless data transmission between two devices without internet.

### 2. Description of the Prior Art

Portable electronic devices, such as smartphones, smart watches, wearable devices, laptops, and tablets, have become indispensable in modern life due to their diverse functionality. As a result, numerous manufacturers have invested in the development of portable electronic devices and supporting operating systems. Various mobile operating systems continue to evolve, including Android, which was jointly developed by Google and Open Handset Alliance (OHA), and iOS developed by Apple Inc.

In addition to performing tasks such as communication, photography, video recording, file editing, and internet access, users may also need to perform data transmission between portable electronic devices and other devices. Wireless data transmission between multiple devices, however, typically requests an internet connection, especially in a cross-operating system scenario (e.g., two devices belonging to different operating systems or different mobile operating systems).

As a result, a novel method for performing wireless data transmission between two devices which does not rely on the internet and is not limited to the same operating system or the same mobile operating system is urgently needed.

### SUMMARY OF THE INVENTION

According to an embodiment of the present invention, a communication device is provided. The communication device comprises a wireless communication module and a processor. The wireless communication module is arranged to transmit or receive multiple wireless signals, and provide a hotspot, wherein the wireless communication module receives a connection request indicating to connect to the hotspot from a peer communication device, and establishes a wireless connection with the peer communication device in response to the connection request. The processor is coupled to the wireless communication module, and is arranged to control operations of the communication device, wherein after the wireless connection is successfully established, the processor utilizes a captive portal mechanism to transmit information associated with a download link to the peer communication device via the wireless communication module; and in response to a download request being received from the peer communication device, the processor transmits predetermined data to the peer communication device via the wireless communication module.

According to an embodiment of the present invention, a data transmission method is provided. The data transmission method comprises: providing, by a communication device, a hotspot via a wireless communication module, and receiving, by the communication device, a connection request indicating to connect to the hotspot from a peer communication device via the wireless communication module; establishing, by the communication device, a wireless connection with the peer communication device in response to the connection request; utilizing, by the communication device, a captive portal mechanism to transmit information associated with a download link to the peer communication device via the wireless communication module after the wireless connection is successfully established; and transmitting, by the communication device, predetermined data to the peer communication device via the wireless communication module in response to a download request being received from the peer communication device.

According to an embodiment of the present invention, a data transmission system is provided. The data transmission system comprises a first communication device and a second communication device. The first communication device is arranged to transmit a connection request to the second communication device for requesting connection to a hotspot provided by the second communication device. The second communication device is arranged to establish a wireless connection with the first communication device in response to the connection request. After the wireless connection is successfully established, the second communication device is further arranged to utilize a captive portal mechanism to transmit information associated with a download link to the first communication device, and transmit predetermined data to the first communication device in response to a download request being received from the first communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data transmission system according to an embodiment of the present invention.

FIG. 2 is a flow chart of performing data transmission between two communication devices according to an embodiment of the present invention.

FIG. 3 is a diagram illustrating a wireless connection established between two communication devices according to an embodiment of the present invention.

FIG. 4 is a diagram illustrating a captive portal page utilized to guide a communication device to directly download predetermined data or files according to an embodiment of the present invention.

FIG. 5 is a flow chart of a data transmission method according to an embodiment of the present invention.

FIG. 6 is a diagram illustrating a message flow of data transmission performed between communication devices or performed within a communication device according to an embodiment of the present invention.

### DETAILED DESCRIPTION

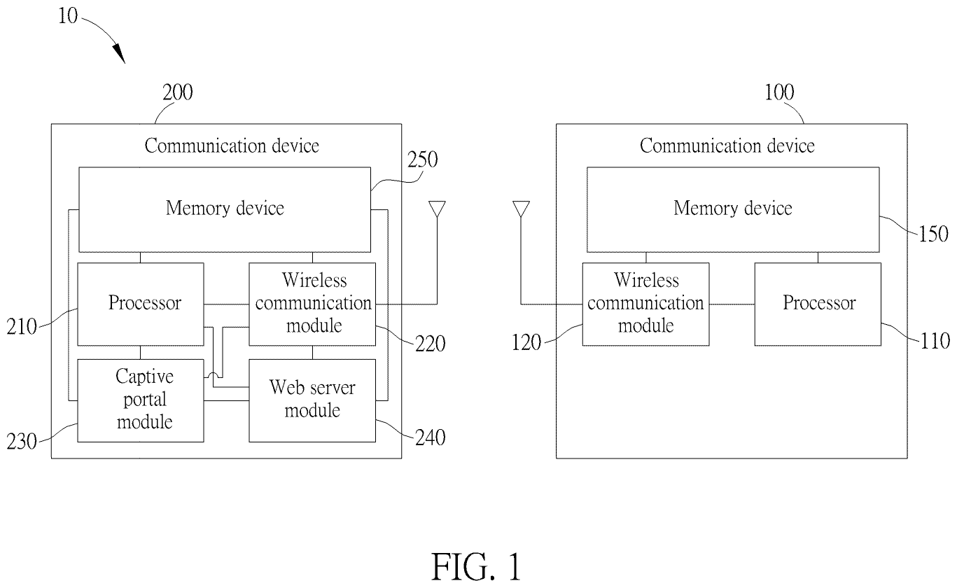

FIG. 1 is a diagram illustrating a data transmission system 10 according to an embodiment of the present invention. The data transmission system 10 may include multiple communication devices, such as communication devices 100 and 200, wherein the communication devices 100 and 200 are peer devices to each other. Each communication device within the data transmission system 10 is equipped with a wireless communication ability, and at least one communication device within the data transmission system 10 is further equipped with a hotspot sharing ability, and can provide a captive portal and web server function.

According to an embodiment of the present invention, the communication device 100 may at least include a processor 110, a wireless communication module 120, and a memory device 150. The processor 110 is coupled to the wireless communication module 120 and the memory device 150, and controls operations of the communication device 100. The communication device 200 may at least include a processor 210, a wireless communication module 220, a captive portal module 230, a web server module 240, and a memory device 250. The processor 210 is coupled to the wireless communication module 220, the captive portal module 230, the web server module 240, and the memory device 250, and controls operations of the communication device 200.

According to an embodiment of the present invention, each of the wireless communication modules 120 and 220 may be a wireless communication device or a wireless communication chip operating according to at least one predetermined wireless communication standard protocol, and may be arranged to transmit or receive multiple wireless signals, and perform corresponding signal processing. For example, each of the wireless communication modules 120 and 220 may be a wireless communication chip operating according to the Institute of Electrical and Electronics Engineers (IEEE) 802.11 standard protocols. As a result, the wireless communication modules 120 and 220 can be equipped with a basic Wireless Fidelity (Wi-Fi) wireless communication ability.

According to an embodiment of the present invention, the wireless communication module 220 may be further equipped with a Wi-Fi hotspot sharing ability for providing a hotspot. The communication device 200 may establish a connection with other communication device (e.g., the communication device 100) in order to form a Wireless Local Area Network (WLAN) through the hotspot, and act as an access point (AP) in the WLAN.

According to an embodiment of the present invention, each of the captive portal module 230 and the web server module 240 may be implemented by a dedicated hardware circuit, or may be implemented by executing a program code via the processor 210, but the present invention is not limited thereto. In an embodiment of the present invention, when the processor 210 executes a corresponding program code for implementing the captive portal and web server function, both the captive portal module 230 and the web server module 240 may be regarded as a part of the processor 210. In another embodiment of the present invention, when the processor 210 executes a corresponding program code for implementing the captive portal and web server function, the captive portal module 230 and the web server module 240 may be respectively implemented by different threads, distinct logic circuits, or separate logical sub-units within the processor 210. In some embodiments, the captive portal module 230 and the web server module 240 may be two independent logical circuits or two independent processor sub-units.

According to an embodiment of the present invention, the communication device 100 may transmit a connection request to the communication device 200 via the wireless communication module 120, for requesting connection to a hotspot provided by the communication device 200. In response to the connection request, the communication device 200 may establish a wireless connection with the communication device 100 via the wireless communication module 220. After the wireless connection is successfully established, the processor 210 may utilize a captive portal mechanism to transmit information associated with a download link to the communication device 100 via the wireless communication module 220. In an embodiment of the present invention, the processor 210 may enable the captive portal module 230 after the wireless connection is successfully established. Alternately, the wireless communication module 220 or the processor 210 may transmit a message for notifying the captive portal module 230 that the wireless connection has been established, such that the captive portal module 230 generates information associated with the download link, and the processor 210 and/or the wireless communication module 220 transmits the information to the communication device 100.

According to an embodiment of the present invention, the information associated with the download link may include a uniform resource locator (URL) of a captive portal page carrying the download link. The captive portal module 230 may present the captive portal page to the communication device 100 via a browser before the communication device 100 is allowed to access the internet normally via the communication device 200. According to an embodiment of the present invention, in response to reception of the information associated with the download link, the communication device 100 may enable a browser, and the captive portal page carrying the download link may be displayed on a user interface of the communication device 100 via the browser, such that the information associated with the download link can be displayed on the user interface.

After receiving the information associated with the download link, the communication device 100 may transmit a download request to the communication device 200. In response to the download request being received from the communication device 100, the processor 210 may directly transmit predetermined data to the communication device 100 via the wireless communication module 220. According to an embodiment of the present invention, the web server module 240 (or the processor 210) may be a web server operated by the communication device 200, and the processor 210 may store the predetermined data in the web server. In addition, the download link provided by the communication device 200 via the captive portal can point to the predetermined data stored in the web server.

In embodiments of the present invention, directly transmitting the predetermined data to the communication device 100 refers to transmitting the predetermined data from the communication device 200 to the communication device 100 via the wireless connection between the two devices, without passing through the internet or any external network. This enables peer-to-peer data transmission between the two devices wirelessly, without relying on the internet. In addition, the communication devices 100 and 200 are not limited to operating on the same operating system or the same mobile operating system. In other words, the data transmission can be efficiently accomplished by performing the method of the present invention regardless of whether the communication devices 100 and 200 operate on the same or different operating systems/mobile operating systems.

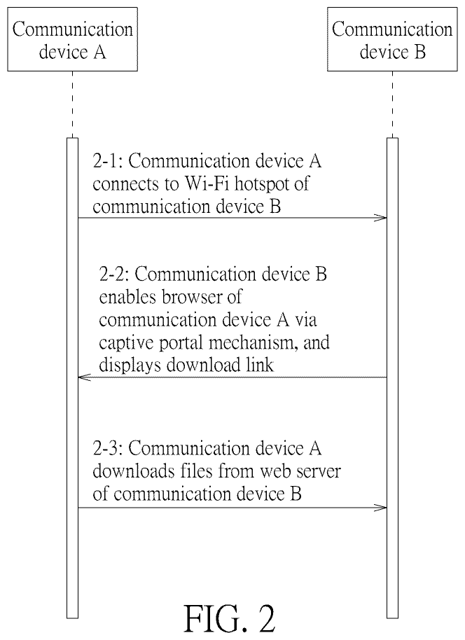

FIG. 2 is a flow chart of performing data transmission between two communication devices according to an embodiment of the present invention. In this embodiment, the data transmission system includes communication devices A and B, wherein the communication devices A and B may correspond to the communication devices 100 and 200 shown in FIG. 1, respectively, and the communication devices A and B are peer devices to each other. In addition, the communication device B is equipped with the Wi-Fi hotspot sharing ability, and may provide the captive portal and web server function.

FIG. 2 briefly illustrates the interaction between the communication devices A and B through the message flow, as well as main operations of the data transmission method proposed by the present invention.

In Operation 2-1, the communication device A is connected to the Wi-Fi hotspot of the communication device B.

In Operation 2-2, the communication device B enables the browser of the communication device A via the captive portal mechanism, and displays the download link.

In Operation 2-3, the communication device A downloads files from the web server of the communication device B.

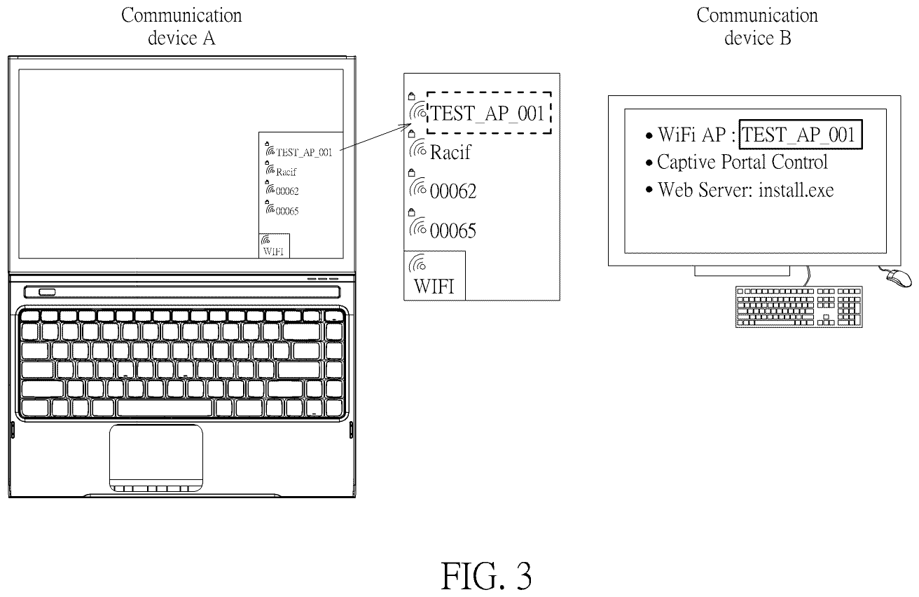

FIG. 3 is a diagram illustrating a wireless connection established between two communication devices according to an embodiment of the present invention. In this embodiment, the data transmission system includes communication devices A and B, wherein the communication devices A and B may correspond to the communication devices 100 and 200 shown in FIG. 1, respectively, and the communication devices A and B are peer devices to each other. In addition, the communication device B is equipped with the Wi-Fi hotspot sharing ability. As shown in FIG. 3, the communication device B may act as a Wi-Fi AP with a hotspot name “TEST_AP_001”, and may provide the captive portal and web server function. The texts “Captive Portal Control” and “Web Server: install.exe” shown in FIG. 3 represent that the communication device B is equipped with the captive portal control ability, and that the communication device B operates a web server storing a file “install.exe”, respectively.

According to an embodiment of the present invention, the communication device A may search for and connect to the hotspot “TEST_AP_001” provided by the communication device B by scanning for available Wi-Fi hotspots. After the communication device A is successfully connected to the communication device B, the communication device B may enable the captive portal mechanism, and display a page on the communication device A that pops up with a message from the communication device B via the captive portal mechanism.

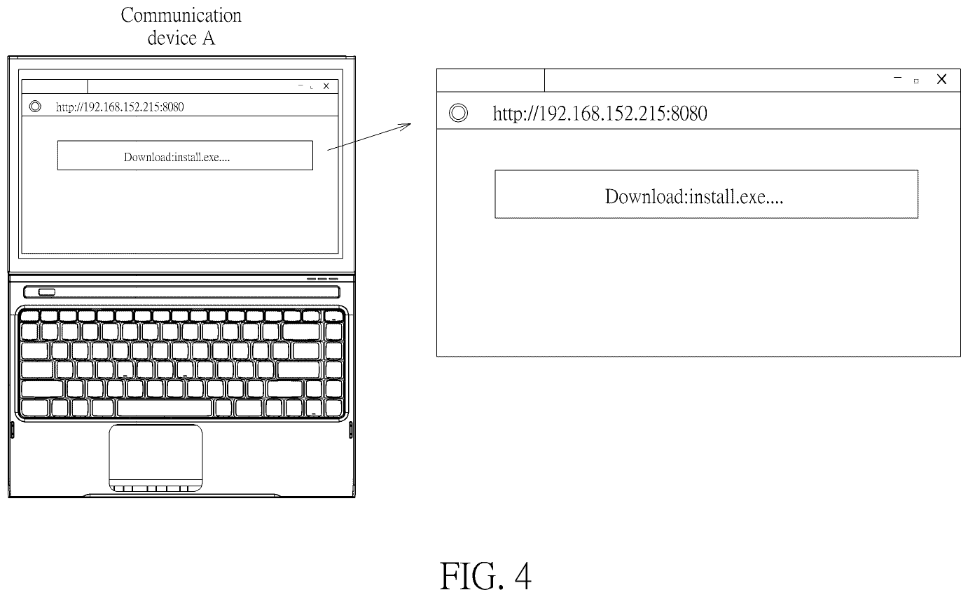

FIG. 4 is a diagram illustrating a captive portal page utilized to guide the communication device A to directly download predetermined data or files stored in the communication device B according to an embodiment of the present invention. In this embodiment, the communication device B (e.g., the communication device 200 or the processor 210 shown in FIG. 1) may utilize the captive portal mechanism to transmit information associated with the download link in order to enable a browser of the communication device A, for displaying a captive portal page on a user interface via the browser. The captive portal page carries a download link, and the download link may point to the file “install.exe” stored in the web server operated by the communication device B, for guiding the communication device A to directly download the file “install.exe” from the communication device B.

The user of the communication device A may click the download link on the captive portal page. In response to detecting a click operation of the download link on the user interface, a processor of the communication device A (e.g., the processor 110 shown in FIG. 1) may transmit a download request to the communication device B via a wireless communication module (e.g., the wireless communication module 120 shown in FIG. 1).

In response to the download request being received from the communication device A, the communication device B may directly transmit the file “install.exe” stored in the web server to the communication device A via a wireless communication module (e.g., the wireless communication module 220 shown in FIG. 1). After the communication device A successfully downloads the file “install.exe”, the data transmission flow of the present invention ends.

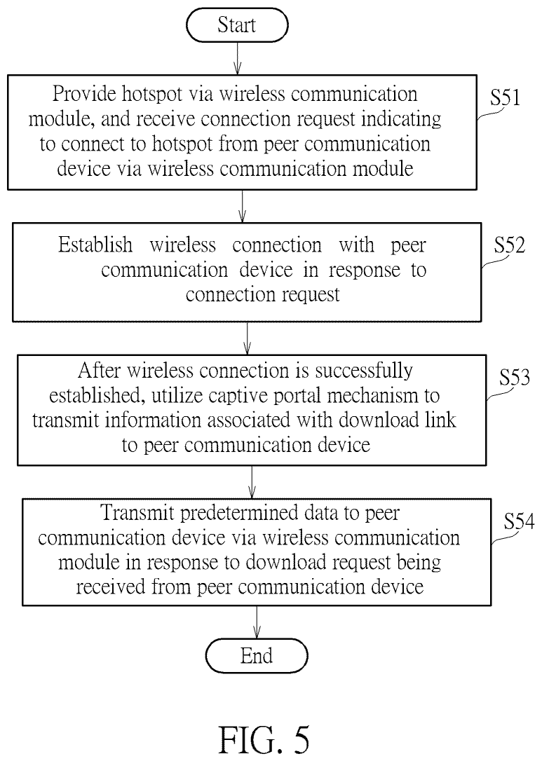

FIG. 5 is a flow chart of a data transmission method according to an embodiment of the present invention.

FIG. 5 illustrates the steps included in the data transmission method of the present invention from the perspective of a communication device equipped with the Wi-Fi hotspot sharing ability and capable of providing the captive portal and web server function (e.g., the communication device 200 or the communication device B).

In Step S51, a hotspot is provided by a communication device via a wireless communication module, and a connection request is received from a peer communication device (e.g., the communication device 100 or the communication device A) via the wireless communication module, for requesting connection to the hotspot.

In Step S52, in response to the connection request, a wireless connection is established between the communication device and the peer communication device.

In Step S53, after the wireless connection is successfully established, the captive portal mechanism is utilized to transmit information associated with a download link to the peer communication device.

In Step S54, in response to a download request being received from the peer communication device, predetermined data is transmitted to the peer communication device via the wireless communication module.

According to an embodiment of the present invention, the information associated with the download link includes a URL of a captive portal page carrying the download link.

According to an embodiment of the present invention, the data transmission method of the present invention further includes operating, by the communication device, a web server, and storing, by the communication device, the predetermined data in the web server, wherein the download link points to the predetermined data stored in the web server.

According to an embodiment of the present invention, the data transmission method of the present invention further includes utilizing, by the communication device, the captive portal mechanism to enable a browser of the peer communication device.

According to an embodiment of the present invention, the data transmission method of the present invention further includes displaying the information associated with the download link on a user interface of the peer communication device via the browser.

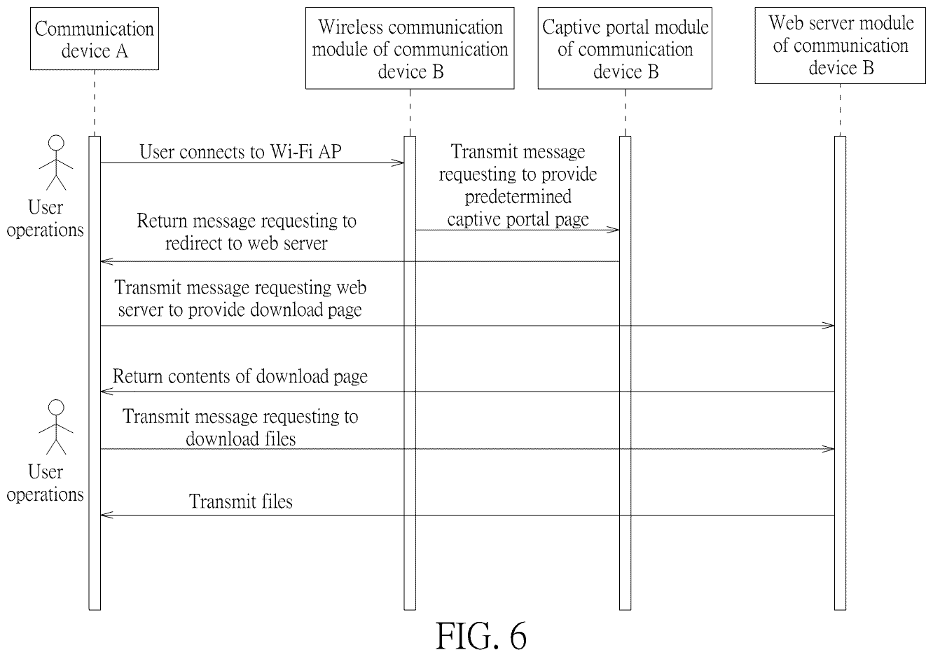

FIG. 6 is a diagram illustrating a message flow of data transmission performed between communication devices or performed within a communication device according to an embodiment of the present invention. In this embodiment, the data transmission system includes communication devices A and B, wherein the communication devices A and B may correspond to the communication devices 100 and 200 shown in FIG. 1, respectively, and may be peer communication devices to each other. In addition, the communication device B is equipped with a Wi-Fi hotspot sharing ability, and can provide a captive portal and web server function.

According to an embodiment of the present invention, a user of the communication device A may search for and connect to the hotspot provided by the communication device B by scanning for available Wi-Fi hotspots (labeled as “User connects to Wi-Fi AP” in FIG. 6).

After the wireless connection is successfully established, a wireless communication module of the communication device B (e.g., the wireless communication module 220 shown in FIG. 1) may transmit a request message to a captive portal module (e.g., the captive portal module 230 shown in FIG. 1) in order to request the captive portal module to provide a predetermined captive portal page (labeled as “Transmit message requesting to provide predetermined captive portal page” in FIG. 6).

According to an embodiment of the present invention, the captive portal page may be set as a download page displaying or carrying a download link in advance, such that the download page can act as the predetermined captive portal page. In response to the request message being received from the wireless communication module, the captive portal module of the communication device B may transmit a URL of the predetermined captive portal page to the communication device A via the wireless communication module. According to an embodiment of the present invention, since the file or predetermined data provided for download to the communication device A is stored in a web server operated by the communication device B, the URL of the captive portal page can redirect to the web server, which is equivalent to returning a redirection request to the communication device A (labeled as “Return message requesting to redirect to web server” in FIG. 6).

In response to the request message indicating to redirect to the web server being received, a browser of the communication device A is enabled, and the communication device A may transmit a request to the web server operated by the communication device B, in order to request the web server to provide contents of the download page carrying the download link (labeled as “Transmit message requesting web server to provide download page” in FIG. 6).

In response to the request message indicating to provide the download link being received, a web server module of the communication device B (e.g., the web server module 240 shown in FIG. 1) may transmit the contents of the download page carrying the download link to the communication device A via the wireless communication module (labeled as “Return contents of download page” in FIG. 6).

In response to the download page being received, the browser of the communication device A may display the download page on a user interface. When the user clicks the download link on the downlink page, the communication device A may transmit a download request to the communication device B (labeled as “Transmit message requesting to download files” in FIG. 6).

In response to the request message indicating to provide the download files being received, the web server module of the communication device B may transmit the files (or the predetermined data) to the communication device A via the wireless communication module (labeled as “Transmit files” in FIG. 6). After the communication device A successfully downloads the files, the data transmission flow of the present invention ends.

In summary, the data transmission method proposed by the present invention can effectively transmit data or files to users within the data transmission system without the need for an external internet connection, wherein the files may include software resources, such as applications provided to users by a communication device. In this way, an automated download process is implemented, allowing the users to be guided to automatically download data or files without manually entering a download URL. In addition, since the data or files are provided by a web server of the communication device within the data transmission system, the risk of accessing external networks is effectively mitigated, thereby ensuring the integrity and security of the data or files. Additionally, the users within the data transmission system only need to connect to Wi-Fi and click the link on the captive portal page to complete the download process, which greatly simplifies the process flow, and makes the data transmission method proposed by the present invention highly convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a wireless communication module, arranged to transmit or receive multiple wireless signals, and provide a hotspot, wherein the wireless communication module receives a connection request indicating to connect to the hotspot from a peer communication device, and establishes a wireless connection with the peer communication device in response to the connection request; and
a processor, coupled to the wireless communication module, and arranged to control operations of the communication device, wherein after the wireless connection is successfully established, the processor utilizes a captive portal mechanism to transmit information associated with a download link to the peer communication device via the wireless communication module; and in response to a download request being received from the peer communication device, the processor transmits predetermined data to the peer communication device via the wireless communication module.

2. The communication device of claim 1, wherein the information associated with the download link comprises a uniform resource locator (URL) of a captive portal page carrying the download link.

3. The communication device of claim 1, wherein the processor utilizes the captive portal mechanism to transmit the information associated with the download link for enabling a browser of the peer communication device.

4. The communication device of claim 3, wherein the information associated with the download link is displayed on a user interface of the peer communication device via the browser.

5. The communication device of claim 1, wherein the processor is further arranged to operate a web server, and the download link points to the predetermined data stored in the web server.

6. A data transmission method, comprising:
providing, by a communication device, a hotspot via a wireless communication module, and receiving, by the communication device, a connection request indicating to connect to the hotspot from a peer communication device via the wireless communication module;
establishing, by the communication device, a wireless connection with the peer communication device in response to the connection request;
utilizing, by the communication device, a captive portal mechanism to transmit information associated with a download link to the peer communication device via the wireless communication module after the wireless connection is successfully established; and
transmitting, by the communication device, predetermined data to the peer communication device via the wireless communication module in response to a download request being received from the peer communication device.

7. The data transmission method of claim 6, wherein the information associated with the download link comprises a uniform resource locator (URL) of a captive portal page carrying the download link.

8. The data transmission method of claim 6, further comprising:
utilizing the captive portal mechanism to enable a browser of the peer communication device.

9. The data transmission method of claim 8, further comprising:
displaying the information associated with the download link on a user interface of the peer communication device via the browser.

10. The data transmission method of claim 6, further comprising:
operating, by the communication device, a web server, and storing, by the communication device, the predetermined data in the web server, wherein the download link points to the predetermined data stored in the web server.

11. A data transmission system, comprising:
a first communication device, arranged to transmit a connection request to a second communication device for requesting connection to a hotspot provided by the second communication device; and
the second communication device, arranged to establish a wireless connection with the first communication device in response to the connection request;
wherein after the wireless connection is successfully established, the second communication device is further arranged to utilize a captive portal mechanism to transmit information associated with a download link to the first communication device, and transmit predetermined data to the first communication device in response to a download request being received from the first communication device.

12. The data transmission system of claim 11, wherein the information associated with the download link comprises a uniform resource locator (URL) of a captive portal page carrying the download link; and the first communication device is further arranged to enable a browser in response to reception of the information associated with the download link, and display the captive portal page carrying the download link on a user interface of the first communication device via the browser.

13. The data transmission system of claim 12, wherein in response to a click on the downlink being detected on the user interface, the first communication device is further arranged to transmit the downlink request to the second communication device.

14. The data transmission system of claim 11, wherein the second communication device is further arranged to operate a web server, and store the predetermined data in the web server.

15. The data transmission system of claim 14, wherein the download link points to the predetermined data stored in the web server.
